(19) United States
(12) Patent Application Publication
(10) Pub. No.: US 2011/0195834 A1
(43) Pub. Date: Aug. 11, 2011

(54) Wear Resistant Two-Phase Binderless Tungsten Carbide and Method of Making Same

(75) Inventors: Debangshu Banerjee, Springdale, AR (US); William Roy Huston, Traverse City, MI (US); Quingjun Zheng, Rogers, AR (US); Beverly Jo Killman, Cedar, MI (US)

(73) Assignee: Kennametal, Inc., Latrobe, PA (US)

(21) Appl. No.: 12/700,991

(22) Filed: Feb. 5, 2010

(51) Int. Cl. C04B 35/56

(52) U.S. Cl. 501/93

(57) ABSTRACT

An ultrafine grain two-phase binderless tungsten carbide material is disclosed. The material contains, in weight percent, ditungsten carbide in the range of about 1 to about 10 percent, up to about 1.0 percent vanadium carbide and/or chromium carbide, up to about 0.2 percent cobalt, and the balance tungsten carbide, wherein the wear resistant material has a hardness of at least about 2,900 kg/mm² and a microstructure in which the tungsten carbide average grain size is no greater than about 0.3 microns. The material has a surprisingly good combination of wear resistance and hardness. Methods of making the material and articles made from the material are also disclosed.

### FIELD OF THE INVENTION

The present invention relates to wear resistant ultrafine grain two-phase binderless tungsten carbide and articles made thereof. More specifically, the present invention relates to wear resistant material consisting primarily of ultrafine grains of tungsten carbide and ditungsten carbide. The present invention also relates to methods of making the inventive ultrafine grain two-phase binderless tungsten carbide and articles therefrom as well as the articles themselves.

### BACKGROUND OF THE INVENTION

Binderless tungsten carbide is used in applications requiring high hardness and wear resistance. Applications for binderless tungsten carbide include pump seals and bodies, dies, drills, cutting tools, pellets for hardfacing, and abrasive fluid machining nozzles to name a few. The term “binderless” is used to differentiate binderless tungsten carbide from cemented tungsten carbide, a material in which a metal such as cobalt or nickel is added during manufacturing to bind together and provide a separation of grains or groups of grains of tungsten carbide from one another. The use of such binder metals increases the toughness of the material, but decreases the material's wear resistance. Typically, such binder metals make up about 2 to 30 weight percent of cemented tungsten carbide. In contrast, no binder metals are intentionally added during the manufacturing of binderless tungsten carbide. Rather, any binder metal, e.g., cobalt or nickel, that is present comes in as a contaminant from the milling process the tungsten carbide undergoes during the manufacture of the binderless tungsten carbide.

An example of an outstanding prior art binderless tungsten carbide is ROTEC® 500 available from Kennametal, Inc. of Latrobe, Pa., US. ROTEC® 500 has a Vickers hardness in the range of about 2,750 to 2,800 kg/mm² and a wear loss measured by the ASTM G76-83 erosion test of about 0.4×10⁻⁶ cm³/gram. This is a two-phase binderless tungsten carbide comprising tungsten carbide and ditungsten carbide and no more than 0.2 weight percent cobalt. It is manufactured by milling 0.4 micron average grain size tungsten carbide powder to produce a low carbon content milled powder in accordance with U.S. Pat. No. 5,612,264 to Nilsson et al. The milled powder is subsequently spray dried into pellets, pressed to shape, presintered, and then further densified using the rapid omnidirectional compaction process, which is described in U.S. Pat. No. 4,744,943 to Timm. When used as the material of construction for an abrasive water jet nozzle it has a useful lifetime that is more than ten times that of cemented tungsten carbide.

Although prior art binderless tungsten carbide provides exceptional wear resistance compared to cemented tungsten carbide, wear still occurs and limits the lifetimes of the components comprising it.

### SUMMARY OF THE INVENTION

The inventors of the present invention have discovered a two-phase binderless tungsten carbide material having an unexpectedly good combination of high wear resistance and high hardness. The two-phase binderless tungsten carbide material consists essentially of, in weight percent, ditungsten carbide in the range of about 1 to about 10 percent, up to about 1.0 percent vanadium carbide and/or chromium carbide, up to about 0.2 percent cobalt, and the balance tungsten carbide, wherein the wear resistant material has a hardness of at least about 2,900 kg/mm² and a microstructure in which the tungsten carbide average grain size is no greater than about 0.3 microns.

One aspect of the present invention provides a wear resistant material comprising such a two-phase binderless tungsten carbide. Another aspect of the present invention provides methods of making such two-phase binderless tungsten carbide materials and articles therefrom. Yet another aspect of the present invention comprises articles comprising such two-phase binderless tungsten carbide materials.

### BRIEF DESCRIPTION OF THE DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 is a graph showing a variation of the erosion rate of two-phase binderless tungsten carbide, which was manufactured from tungsten carbide powder having a 0.2 micron average particle size, as a function of the level of ditungsten carbide in the material.

FIG. 2 is a graph comparing the variation of hardness as a function of ditungsten carbide content for the two-phase binderless tungsten carbide of the present invention and prior art two-phase binderless tungsten carbide.

### DESCRIPTION OF PREFERRED EMBODIMENTS OF THE INVENTION

In this section, some preferred embodiments of the present invention are described in detail sufficient for one skilled in the art to practice the present invention. It is to be understood, however, that the fact that a limited number of preferred embodiments are described herein does not in any way limit the scope of the present invention as set forth in the appended claims.

All compositions are referred to herein in terms of weight percent.

The present invention provides ultrafine grain wear resistant two-phase binderless tungsten carbide materials consisting essentially of ditungsten carbide in the range of about 1 to about 10 percent, up to about 1.0 percent vanadium carbide and/or chromium carbide, up to about 0.2 percent cobalt, and the balance tungsten carbide, wherein the materials have a hardness of at least about 2,900 kg/mm² and a microstructure in which the tungsten carbide average grain size is no greater than about 0.3 microns.

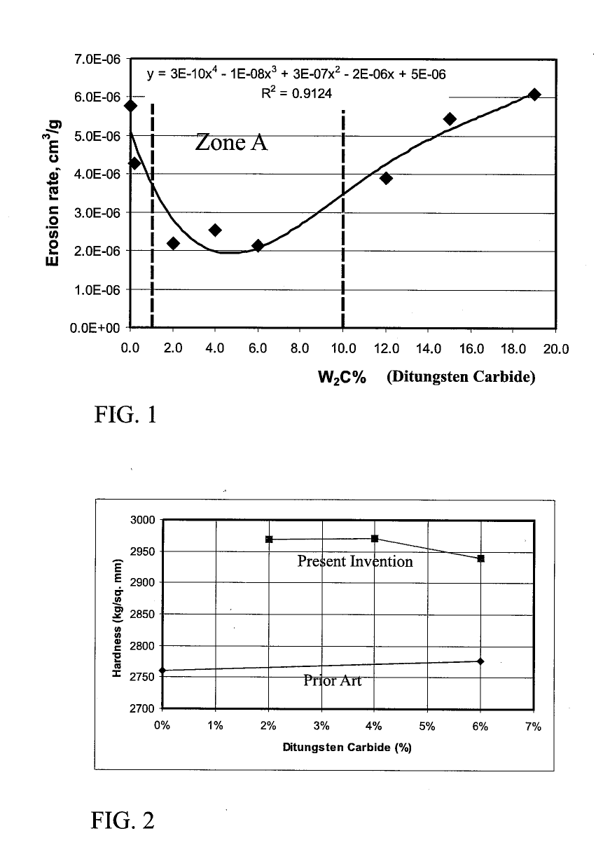

Persons skilled in the art know that stoichiometric tungsten carbide has a carbon content of 6.13 percent and that ditungsten carbide has a carbon content of 3.16 percent. In contrast, the two-phase tungsten carbide portion of the composition of the present invention has a carbon content of between about 6.10 and about 5.84 percent and has a ditungsten carbide content of between about 1 and about 10 percent. The inventors of the present invention have discovered that the material's wear resistance deteriorates when the carbon and ditungsten carbide contents are outside of these ranges, as is illustrated in FIG. 1. Preferably, the carbon and ditungsten carbide contents are, respectively, between about 6.07 percent and about 2 percent and about 5.9 and about 8 percent. More preferably the carbon and ditungsten carbide contents are, respectively, between about 6.04 percent and about 3 percent and about 5.93 and about 7 percent, respectively.

Referring now to FIG. 1, there is shown a graph of the erosion rate, as measured in accordance with ASTM G76 using silicon carbide particles, as a function of the carbon and ditungsten carbide contents of two-phase binderless tungsten carbide manufactured from tungsten carbide powder having a 0.2 micron average particle size as described in Example 1 below. Persons skilled in the art will recognize that lower erosion rate values produced by this test indicate better wear resistance. The two-phase binderless tungsten carbide materials of the present invention are the compositions falling in Zone A limited by the dashed vertical lines at ditungsten carbide contents of 1 and 10 percent.

As evidenced by FIG. 1, the inventors of the present invention have discovered that the two-phase binderless tungsten carbide materials of the present invention has surprisingly better levels of wear resistance than do two-phase binderless tungsten carbide materials having ditungsten carbide levels outside of the range of the present invention.

Embodiments of the present invention may contain vanadium carbide, chromium carbide, or combinations of the two wherein the amount of either material or their combined amount is no more than about 1.0 weight percent. Vanadium carbide and chromium carbide, when present, act to inhibit the grain growth of the tungsten carbide and the ditungsten carbide grains. The presence of these grain growth inhibitors makes the material more robust with regard to avoiding grain growth during exposure of the material to high temperature during the consolidation processing steps in making the two-phase binderless tungsten carbide material of the present invention. However, amounts of these grain growth inhibitors, either alone or in combination with one another, greater than 1.0 percent provide no further grain growth inhibition benefit, but instead may cause a deterioration of other physical properties of the material, e.g. fracture toughness.

The grain size of the tungsten carbide and ditungsten carbide grains in the two-phase binderless tungsten carbide materials of the present invention are no greater than 0.3 microns. Average grain sizes larger than 0.3 microns result in a loss of hardness. Preferably, the average grain size is in the range of from about 0.1 to about 0.3 microns as it becomes more difficult to avoid localized grain growth when the average grain size is below 0.2. The average grain size is measured using the line intercept method on microstructures of the inventive material observed by high resolution Scanning Electron Microscopy. Those skilled in the art will understand that electron microscopy is required because the small grain sizes of the materials of the present invention are at or beyond the resolving power of usual optical microscopy. The grain size distribution is preferably substantially uniform, that is, there are very few grains have individual dimensions over 1 microns.

The two-phase binderless tungsten carbide materials of the present invention have hardness values of about 2,900 kg/mm² or higher and preferably 2,950 kg/mm² or higher. The hardness measurements are made according using a Vicker's micro indentor with a load of 1 kg. Materials softer than 2,900 kg/mm² result in an inferior material. FIG. 2 shows improvement in hardness provided by the materials of the present invention in comparison to similar materials having larger grain size. In contrast, as also can be seen in the figure, the ditungsten carbide content of the material has very little effect on the hardness.

Methods of making the two-phase binderless tungsten carbide materials of the present invention and articles therefrom will now be described. The first step is to provide tungsten carbide powder having an average particle size of no greater than about 0.2 microns, as measured by the high resolution Scanning Electron Microscopy. The tungsten carbide powder is milled, e.g., by ball milling or attritor milling, in a liquid to deagglomerate the powder, to add a pressing binder, e.g., paraffin, and to further reduce the particle size to obtain the desired grain size in the consolidated material. If the carbon level of the tungsten carbide powder differs from that needed to obtain the desired carbon level in the consolidated material, additions may be made to the tungsten carbide powder either before, e.g., by blending, or during the milling. If the carbon level of the tungsten carbide is too low, a carbon source material, e.g., carbon black or a tungsten carbide powder having a sufficiently high carbon level, may be added to the tungsten carbide powder. If the carbon level is too high, any of the carbon level reducing methods described in the aforementioned U.S. Pat. No. 5,612,264 may be employed, e.g., by adding a carbon dilutant, e.g., tungsten powder or tungsten oxide powder.

If either or both of the grain growth inhibitors vanadium carbide and chromium carbide are desired in the final product, a tungsten carbide powder containing these materials can be used. Alternatively, these materials may be added before or during the milling step either in their pure forms or dissolved in or part of another material addition, e.g., part of the material added to adjust the carbon level.

Upon completion of the milling step, the milled powder is dried and, preferably, granulated. The powder may then be pressed in a mold to form the desired shape. The shaped powder may then be heated in a hydrogen, vacuum or inert atmosphere such as argon or nitrogen to eliminate the pressing binder and then heated to a temperature in the range of about 1,200 to about 1,400° C. in a vacuum to sinter the powder together into a sintered article. The sintered article may then be further consolidated to a high density by the application of high temperature and pressure. This consolidation is preferably done by using the rapid omnidirectional consolidation process, also known as the ROC process, which is described in the aforementioned U.S. Pat. No. 4,744,943. Preferably, the sintered article is wrapped in graphite foil and then surrounded by glass powder in a mold, heated to a temperature in the range of about 1,400 to about 1,500° C. and then pressed at 8,400 kg/cm² (120,000 psi). After cooling, the consolidated article is removed from the glass and graphite foil. The consolidated article preferably has a relative density of at least 99 percent. Additional processing may be employed as desired to further shape the consolidated article. For example, when the final article is to be an abrasive fluid machining nozzle, the outer diameter of the consolidated article is ground to size and a bore is machined into the article using plunge electrodischarge machining (EDM).

The present invention also contemplates the use of other consolidation processing methods to produce the consolidated article from the milled powder. In one such method, the sintered article described in the previous paragraph may be further consolidated by hot pressing under suitable conditions, e.g., at a temperature of 2,000° C. and pressure of 5,000 psi, to achieve the desired relative density. Another such method is the sinter-HIP method. In this method, the article is vacuum sintered, e.g., at a temperature of 1,900° C. followed by HIPing using argon gas at a pressure of 105 kg/cm² (1,500 psi). In yet another such method, the milled powder is sintered at 1,900° C. in vacuum at 1,800 C and then hard-HIPed at 1,400 to 2,100 kg/cm² (20,000 to 30,000 psi).

The aforementioned methods of the present invention may be used to make wear resistant two-phase binderless tungsten carbide articles of any desired kind Some preferred articles are abrasive waterjet primary nozzles, EDM guides, industrial blast nozzles, waste water treatment blocks, flow control devices for oil and gas, hardfacing pellets, and guide rolls for wire drawing.

### EXAMPLES

### Example 1

Samples of two-phase binderless tungsten carbide were prepared. First, tungsten carbide powder containing 0.4 percent vanadium carbide and 0.3 percent chromium carbide and having an average grain size of 0.2 microns and a carbon content of 6.12 percent were attritor milled in heptane for 24 hours with selected amounts of a carbon dilutant, tungsten powder, and to result in ditungsten carbide levels in the range of 0 to 20 percent. The slurries also included 2 percent paraffin wax as a pressing binder. The slurries were dried and the resultant powder was pressed into cylinders. The cylinders were dewaxed in hydrogen and sintered in vacuum at 1,400° C. for 60 minutes. The sintered cylinders were wrapped in graphite foil and surrounded by borosilicate glass powder and consolidated to a relative density of 99.7 percent by rapid omnidirectional compaction done at 1,400° C. and 8,400 kg/cm² (120,000 psi). The amount of ditungsten carbide present in each sample was determined by x-ray diffraction. The wear resistance levels of the consolidated samples were then determined by measuring the erosion rate of the samples in accordance with ASTM G76 using silicon carbide particles. The results of the erosion rate tests are given in Table 1 and are graphed in FIG. 1. The results show unexpectedly superior wear resistance of samples of the present invention, i.e., those having between about 1 and 10 percent ditungsten carbide contents, over those having ditungsten carbide levels outside of that range.

TABLE 1

| | Ditungsten | ASTM G 76 | |
|---|---|---|---|
| | Carbide | Erosion Rate | Hardness |
| Sample Type | (%) | (cm³/g × 10⁻⁶) | (kg/mm²) |
| Comparative | 0.0 | 5.77 | 2,920 |
| Comparative | 0.2 | 4.27 | 3,021 |
| Present Invention | 2.0 | 2.19 | 2,969 |
| Present Invention | 4.0 | 2.53 | 2,970 |
| Present Invention | 6.0 | 2.14 | 2,939 |
| Comparative | 12.0 | 3.89 | 3,040 |
| Comparative | 15.0 | 5.46 | — |
| Comparative | 19.0 | 6.10 | — |

The average grain size of the sample of the present invention having a ditungsten carbide content of 5 percent was measured by x-ray diffraction using scanning electron microscopy. The average grain size was determined to be 0.2 microns.

The hardness levels of several of the samples was measured in accordance with ASTM E384. The results of these tests are shown in Table 1. Note that even though the hardness levels of the comparative sample having ditungsten carbide contents below and above that of the present invention are similar to or higher than the hardness levels of the samples of the present invention, the erosion rates of the comparative samples are inferior to, i.e., higher than, those of the samples of the present invention.

### Comparative Example

A comparative sample of a two-phase binderless tungsten carbide having a 6% ditungsten carbide content was prepared using the conditions described in Example 1, except that that the particle size of the tungsten carbide powder used was 0.4 microns and amount of grain growth inhibitor was slightly different, i.e., 0.4 percent vanadium carbide and 0 percent chromium carbide. The wear resistance of the material, as indicated by erosion rate, was measured in the manner described in Example 1. The erosion rate of the comparative sample was 2.97×10⁻⁶ cm³/g, which is 39 percent higher than the erosion rate of 2.14×10⁻⁶ cm³/g that was measured for the sample of the present invention having the same amount of ditungsten carbide.

The hardness of this comparative sample was measured in the manner described in Example 1. The hardness was measured as being 2,777 kg/mm². In contrast, the sample of the present invention having the same ditungsten carbide level was measured as 2,939 kg/mm², which is 6 percent higher than that of the comparative sample.

While only a few embodiments of the present invention have been shown and described, it will be obvious to those skilled in the art that many changes and modifications may be made thereunto without departing from the spirit and scope of the present invention as described in the following claims. All patent applications and patents, both foreign and domestic, and all other publications referenced herein are incorporated herein in their entireties to the full extent permitted by law.

What is claimed is:

1. A wear resistant material consisting essentially of, in weight percent, ditungsten carbide in the range of from about 1 to about 10 percent, up to about 1 percent vanadium carbide, chromium carbide, or a combination thereof, up to about 0.2 percent cobalt, and the balance tungsten carbide, wherein the wear resistant material has a hardness of at least about 2,900 kg/mm² and a microstructure in which the tungsten carbide average grain size is no greater than about 0.3 microns.

2. The wear resistant material of claim 1, wherein the hardness is at least about 2,950 kg/mm².

3. The wear resistant material of claim 1, wherein the ditungsten carbide is in the range of from about 2 to about 8 percent.

4. The wear resistant material of claim 1, wherein the ditungsten carbide is in the range of from about 3 to about 7 percent.

5. The wear resistant material of claim 1, wherein the average grain size is in the range of from about 0.1 to about 0.3 microns.

6. A method for making a wear resistant material comprising the step of consolidating a tungsten carbide powder to form an article having a relative density of at least about 99 percent, an average grain size of no greater than about 0.3 microns, a hardness of at least about 2,900 kg/mm², and a ditungsten carbide content in the range of from about 1 to about 10 weight percent, wherein the article contains no more than about 0.2 weight percent cobalt, and the combined amount of vanadium carbide and chromium carbide is no greater than about 1 weight percent.

7. The method of claim 6, further comprising the step of wet milling the tungsten carbide powder prior to the step of consolidation, wherein the tungsten powder has a particle size of no greater than about 0.2 microns prior to the step of milling.

8. The method of claim 7, further comprising the step of adjusting the carbon level of the article by milling a carbon source or a carbon dilutant material with the tungsten carbide material during the step of milling.

9. The method of claim 6, wherein the ditungsten carbide content is in the range of about 2 to about 8 weight percent.

10. The method of claim 6, wherein the ditungsten carbide content is in the range of about 3 to about 7 weight percent.

11. The method of claim 6, wherein the average grain size is in the range of from about 0.1 to about 0.3 microns.

12. The method of claim 6, wherein the step of consolidating includes the steps of (a) pressing the tungsten carbide powder after the milling step to form a pressed article, (b) sintering the pressed article to form a sintered article, and (c) rapid omnidirectional compacting the sintered article.

13. The method of claim 6, the wherein the hardness is at least about 2,950 kg/mm².

14. An article comprising a wear resistant material consisting essentially of, in weight percent, ditungsten carbide in the range of from about 1 to about 10 percent, up to about 1 percent vanadium carbide, chromium carbide, or a combination thereof, up to about 0.2 percent cobalt, and the balance tungsten carbide, wherein the wear resistant material has a hardness of at least about 2,900 kg/mm² and a microstructure in which the tungsten carbide average grain size essentially is no greater than about 0.3 microns.

15. The article of claim 14, wherein the article is one selected from the group consisting of abrasive waterjet primary nozzles, EDM guides, industrial blast nozzles, waste water treatment blocks, flow control devices for oil and gas, and hardfacing pellets.

16. The article of claim 14, wherein the hardness is at least about 2,950 kg/mm².

17. The article of claim 14, wherein the ditungsten carbide is in the range of from about 2 to about 8 percent.

18. The article of claim 14, wherein the ditungsten carbide is in the range of from about 3 to about 7 percent.

19. The article of claim 12, wherein the average grain size is in the range of from about 0.1 to about 0.3 microns.
